(19) United States
(12) Patent Application Publication
(10) Pub. No.: US 2016/0196949 A1
(43) Pub. Date: Jul. 7, 2016

(54) ATMOSPHERIC IONIZER INCLUDING A SOURCE THAT SUPPLIES ELECTRICAL ENERGY TO AN ION-GENERATING STRUCTURE WITHOUT WIRES

(71) Applicant: Transforming Technologies, LLC, Toledo, OH (US)

(72) Inventors: Thomas Watkins, Sylvania, OH (US); Larry Levit, Alamo, CA (US); Geoff Weil, Marysville, WA (US)

(73) Assignee: TRANSFORMING TECHNOLOGIES, LLC, Toledo, OH (US)

(21) Appl. No.: 14/839,119

(22) Filed: Aug. 28, 2015

Related U.S. Application Data
(60) Provisional application No. 62/099,302, filed on Jan. 2, 2015.

(51) Int. Cl. H01J 27/26

(52) U.S. Cl. CPC H01J 27/26

(57) ABSTRACT

An atmospheric ionizer includes a source that supplies electrical energy to an ion-generating structure without the use of wires or other connecting structures that penetrate an intervening wall or other structure. A tool a plurality of panels that define an enclosure. An atmospheric ionizer includes a source of energy disposed on one side of one of the panels of the tool. A capacitive coupling is connected to the source of energy. An ion-generating structure is disposed on an opposite side of the panel of the tool and is connected to the capacitive coupling. As a result, energy from the source of energy is supplied by the capacitive coupling through the panel of the tool to the ion-generating structure.

### CROSS-REFERENCE TO RELATED APPLICATIONS

This application claims the benefit of U.S. Provisional Application No. 62/099,302, filed Jan. 2, 2015, the disclosure of which is incorporated herein by reference.

### BACKGROUND OF THE INVENTION

This invention relates in general to atmospheric ionizers that are used to reduce or eliminate the amount of electrostatic charge that is present on the surface of an object located within an atmospheric environment, such as air, nitrogen, or other ionizable gasses. In particular, this invention relates to an improved structure for such an atmospheric ionizer that includes a source that supplies electrical energy to an ion-generating structure without the use of wires or other physical connecting structures.

It is well known that the presence of an electrostatic charge (i.e., an unbalanced quantity of either positively or negatively charged particles) on the surface of an electrically insulative object can result in the occurrence of certain physical phenomena. For example, the presence of such an electrostatic charge can attract particulates floating in the atmosphere to move toward and be retained upon the surface of the object. Also, such an electrostatic charge can be rapidly discharged from the object (in the form of a spark) when an electrically conductive material is positioned nearby. In some instances, such as in the use of precision measuring devices and in the manufacture and assembly of electronic integrated circuits, the occurrence of these and other electrostatic physical phenomena is undesirable. Thus, a variety of structures have been developed to reduce or eliminate the amount of electrostatic charge that is present on the surface of the object located within an atmospheric environment.

One well known structure that is widely used to reduce or eliminate the amount of electrostatic charge that is present on the surface of the object is an atmospheric ionizer. In general, atmospheric ionizers generate a flow of electrically charged atmospheric molecules (i.e., ions) through the atmosphere toward the surface of the object. These ions combine with the electrostatic charge that is present on the surface of the object, thereby reducing or eliminating the amount of the electrostatic charge thereon. To accomplish this, a typical atmospheric ionizer includes a source of electrical energy that is connected through one or more wires to an ion-generating structure. When energized by the source of electrical energy, the ion-generating structure generates the flow of electrically charged atmospheric molecules through the atmosphere toward the surface of the object.

In many instances, the atmospheric ionizer is used in conjunction with a precision measuring or automated manufacturing device including a sealed chamber, within which are disposed a measurement or manufacturing device, the ion-generating structure, and an object to be measured or manufactured. One non-limiting example of such a measurement or manufacturing device is illustrated in FIG. 1, which shows a conventional automated process tool, indicated generally at 10. The conventional automated process tool 10 includes a plurality of enclosure panels 11 that define a sealed chamber. A measurement or manufacturing device (not shown) is disposed within the sealed chamber defined by the plurality of enclosure panels 11 and is adapted to support or otherwise interact with an object (not shown) to be measured or manufactured. FIG. 2 illustrates a conventional atmospheric ionizer, indicated generally at 12, that can be used in conjunction with the automated process tool 10. The illustrated atmospheric ionizer 12 includes a source of electrical energy 13 that is connected through one or more wires 14 to an ion-generating structure 15. As best shown in FIG. 2, the wires 14 extend through an opening 11a formed through one of the enclosure panels 11 to connect the source of electrical energy 13 to the ion-generating structure 15. When energized by the source of electrical energy 13, the ion-generating structure 15 generates the flow of electrically charged molecules toward the surface of the object.

Although known precision measuring or manufacturing devices of the type illustrated in FIGS. 1 and 2 have functioned satisfactorily, the use of wires extending through openings formed through one or more of the enclosure panels has been found to be inconvenient or otherwise undesirable. This is because the use of such openings may degrade the ability of the precision measuring or manufacturing device to maintain a sealed environment. Also, the creation of such an opening usually requires that a permanent alternation be made in what is typically a very expensive tool. Thus, it would be desirable to provide an improved structure for an atmospheric ionizer that includes a source that supplies electrical energy to the ion-generating structure without the use of wires or other connecting structures that penetrate an intervening wall or other structure.

### SUMMARY OF THE INVENTION

This invention relates to an improved structure for an atmospheric ionizer including a source that supplies electrical energy to an ion-generating structure without the use of wires or other connecting structures that penetrate an intervening wall or other structure. A tool a plurality of panels that define an enclosure. An atmospheric ionizer includes a source of energy disposed on one side of one of the panels of the tool. A capacitive coupling is connected to the source of energy. An ion-generating structure is disposed on an opposite side of the panel of the tool and is connected to the capacitive coupling. As a result, energy from the source of energy is supplied by the capacitive coupling through the panel of the tool to the ion-generating structure.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a perspective view of a conventional automated process tool that includes a known atmospheric ionizer.

FIG. 2 is an enlarged schematic view of the conventional atmospheric ionizer and a portion of the conventional automated process tool illustrated in FIG. 1.

FIG. 3 is a perspective view of an automated process tool that includes an improved atmospheric ionizer in accordance with this invention.

FIG. 4 is an enlarged schematic diagram of the improved atmospheric ionizer and a portion of the automated process tool illustrated in FIG. 3.

FIG. 5 is a further enlarged side elevational view of a portion of the improved atmospheric ionizer and a portion of the automated process tool illustrated in FIGS. 3 and 4.

FIG. 6 is a schematic diagram of an effective electrical circuit for the improved atmospheric ionizer illustrated in FIGS. 3 through 5.

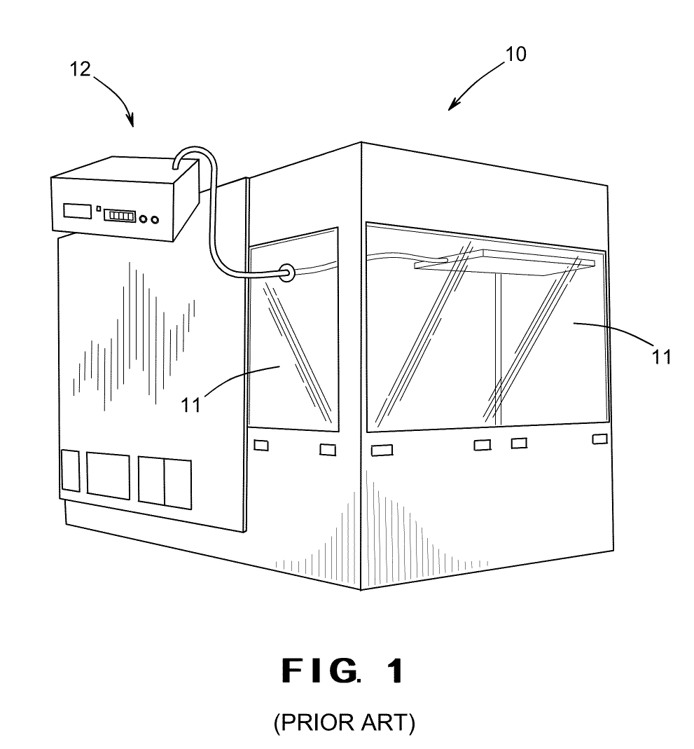

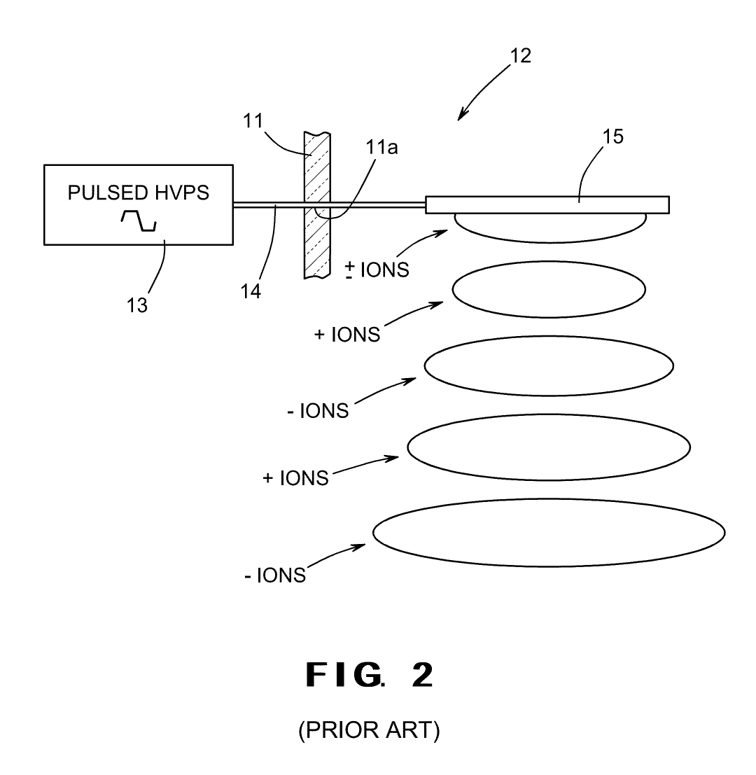

### DETAILED DESCRIPTION OF THE PREFERRED EMBODIMENT

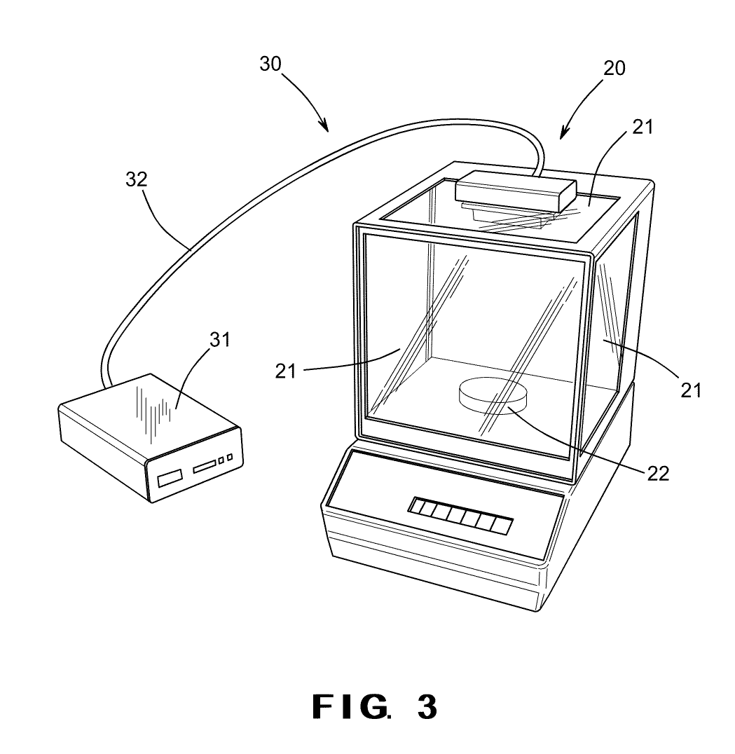

Referring now to the drawings, there is illustrated in FIG. 3 an automated process tool, indicated generally at 20, in accordance with this invention. The illustrated automated process tool 20 is, in large measure, conventional in the art and is intended merely to illustrate one environment in which this invention may be used. Thus, the scope of this invention is not intended to be limited for use with the specific structure for the automated process tool 20 illustrated in FIG. 3 or with automated process tools in general. On the contrary, as will become apparent below, this invention may be used in any desired environment, in conjunction with any desired device or combination of devices, and for any desired purpose.

The illustrated automated process tool 20 includes a plurality of enclosure panels 21 that define a sealed chamber. A conventional measurement or manufacturing device 22 is disposed within the sealed chamber defined by the plurality of enclosure panels 21. During use, an object (not shown) is inserted within the sealed chamber defined by the plurality of enclosure panels 21 and disposed upon or adjacent to the measurement or manufacturing device 22. The illustrated measurement or manufacturing device 20 includes an atmospheric ionizer, indicated generally at 30, in accordance with this invention. As discussed above, the atmospheric ionizer 30 is used to reduce or eliminate the amount of electrostatic charge that is present on the surface of the object disposed upon or adjacent to the measurement or manufacturing device 22.

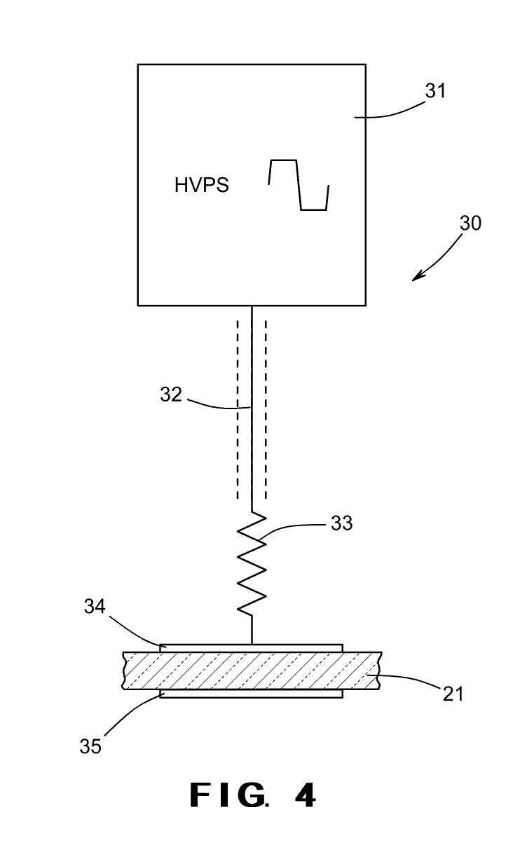

FIG. 4 illustrates the basic structure of the atmospheric ionizer 30. As shown therein, the atmospheric ionizer 30 includes a source of electrical energy 31. The source of electrical energy 31 is, as shown in FIGS. 3 and 4, located outside of the sealed chamber defined by the plurality of enclosure panels 21. The source of electrical energy 31 may, for example, be a pulsed high voltage AC supply, such as a Model ABT controller that is commercially available from Transforming Technologies, LLC of Toledo, Ohio. The Model ABT controller can produce a high voltage square wave output signal having an adjustable ON time (such as in the range of from about 100 ms to about 4 sec, for example) and an adjustable amplitude (such as in the range of from about 400 volts to about 2400 volts, for example). However, this invention contemplates that the source of electrical energy 31 can provide any desired output signal or combination of output signals.

The output signal from the source of electrical energy 31 is fed through a line 32 and a resistor 33 to a first electrode 34. The line 32 may be embodied as any conventional electrical conductor that can transmit electricity from the source of electrical energy 31 to the first electrode 34, such as a flexible shielded cable, for example. The resistor 33 is optional, but is preferably provided to isolate the first electrode 34 from the source of electrical energy 31 and, thus, limit the amount of electrical current supplied from the source of electrical energy 31 to the first electrode 34. To accomplish this, the value of the resistor 33 may, for example, be about 1 mega-ohm or any other relatively large magnitude.

The first electrode 34 is disposed on or adjacent to an outer surface of one of the plurality of enclosure panels 21 that defines the sealed chamber of the automated process tool 20. Preferably, the first electrode 34 directly engages the outer surface of the enclosure panel 21. The first electrode 34 may be retained on the outer surface of the enclosure panel 21 in any desired manner, such as by an adhesive, for example. The first electrode 34 may, for example, be formed from anodized aluminum or stainless steel and be shaped in the formed of a rectangle having side dimensions of about 1 cm by 5 cm. However, the first electrode 34 may be formed from any desired electrically conductive material or combination of materials and have any desired shape or thickness.

Similarly, a second electrode 35 is disposed on or adjacent to an inner surface of the one of the plurality of enclosure panels 21 that defines the sealed chamber of the automated process tool 20. Preferably, the second electrode 35 directly engages the inner surface of the illustrated enclosure panel 21. The second electrode 35 may be retained on the inner surface of the enclosure panel 21 in any desired manner, such as by a low out-gassing adhesive, for example. The second electrode 35 may also, for example, be formed from anodized aluminum or stainless steel and be shaped in the formed of a rectangle having side dimensions of about 1 cm by 5 cm. However, the second electrode 35 may be formed from any desired electrically conductive material or combination of materials and have any desired shape or thickness.

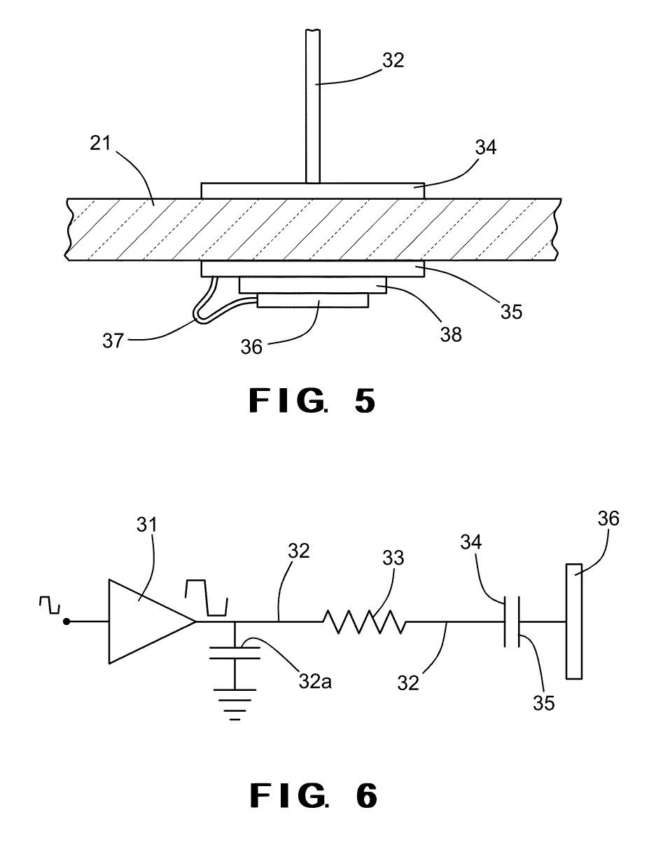

Preferably, the first and second electrodes 34 and 35 are formed having the same shape and size and are directly aligned with one another, as best shown in FIGS. 4 and 5. Thus, the first and second electrodes 34 and 35 define a capacitive coupling. As is well known, the term capacitive coupling refers to the transfer of energy within an electrical network by means of a capacitance established between two nodes. In this instance, the electrical energy supplied from the source of electrical energy 31 to the first electrode 34 is transferred capacitively through the enclosure panel 21 to the second electrode 35.

Preferably, the second electrode 35 is directly connected to an ion-generating structure 36 disposed within the automated process tool 20. However, as best shown in FIG. 5, the second electrode 35 may alternatively be indirectly connected by a wire 37 or other electrical conductor to the ion-generating structure 38. In this instance, a layer of electrically insulative material 38 may be disposed between the second electrode 35 and the ion-generating structure 36, although such is not required. In either event, when the electrical energy supplied from the source of electrical energy 31 is transferred capacitively to the second electrode 35, such electrical energy is supplied to the ion-generating structure 36. In response thereto, the ion-generating structure 36 generates a flow of electrically charged atmospheric molecules toward the surface of the object, in the same manner as described above.

Thus, the atmospheric ionizer 30 of this invention delivers electrical energy from the source of electrical energy 31 to the ion-generating structure 36 through the enclosure panel 21 by means of the capacitive coupling provided by the first and second electrodes 34 and 35. As a result, no wires or other electrical connecting structures are needed, thereby eliminating the need to form openings through the enclosure panel 21, and the integrity of the sealed enclosure of the illustrated electronic scale assembly 20 is maintained. The capacitive coupling may be embodied as any other structure that can supply energy from the source of electrical energy through the enclosure panel 21 to the ion-generating structure without the use of wires or other physical electricity-transmitting components.

FIG. 6 is a schematic diagram of an effective electrical circuit for the improved atmospheric ionizer illustrated in FIGS. 3 through 5, including the source of electrical energy 31, parasitic capacitance 32a of the cable 32, the energy isolating resistor 33, the first and second electrodes 34 and 35, and the ion-generating structure 36.

The principle and mode of operation of this invention have been explained and illustrated in its preferred embodiment. However, it must be understood that this invention may be practiced otherwise than as specifically explained and illustrated without departing from its spirit or scope.

What is claimed is:

1. An atmospheric ionizer comprising:
a source of energy;
a capacitive coupling connected to the source of energy; and
an ion-generating structure connected to the capacitive coupling such that energy from the source of energy is supplied by the capacitive coupling to the ion-generating structure.

2. The atmospheric ionizer defined in claim 1 wherein the source of energy is a source of electrical energy.

3. The atmospheric ionizer defined in claim 1 wherein the capacitive coupling includes a first electrode connected to the source of energy and a second electrode connected to the ion-generating structure.

4. The atmospheric ionizer defined in claim 3 wherein a resistor is connected between the source of energy and the first electrode.

5. The atmospheric ionizer defined in claim 3 wherein the first and second electrodes are formed from the same material.

6. The atmospheric ionizer defined in claim 3 wherein the first and second electrodes are formed having the same shape and size.

7. The atmospheric ionizer defined in claim 3 wherein the first and second electrodes are directly aligned with one another.

8. A combined tool and atmospheric ionizer comprising:
a tool including a panel; and
an atmospheric ionizer including a source of energy disposed on one side of the panel of the tool, a capacitive coupling connected to the source of energy, and an ion-generating structure disposed on an opposite side of the panel of the tool and connected to the capacitive coupling such that energy from the source of energy is supplied by the capacitive coupling through the panel of the tool to the ion-generating structure.

9. The combined tool and atmospheric ionizer defined in claim 8 wherein the tool includes a plurality of panels that define an enclosure.

10. The combined tool and atmospheric ionizer defined in claim 8 wherein the source of energy is a source of electrical energy.

11. The atmospheric ionizer defined in claim 8 wherein the capacitive coupling includes a first electrode connected to the source of energy and a second electrode connected to the ion-generating structure.

12. The atmospheric ionizer defined in claim 11 wherein a resistor is connected between the source of energy and the first electrode.

13. The atmospheric ionizer defined in claim 11 wherein the first and second electrodes are formed from the same material.

14. The atmospheric ionizer defined in claim 11 wherein the first and second electrodes are formed having the same shape and size.

15. The atmospheric ionizer defined in claim 11 wherein the first and second electrodes are directly aligned with one another.
